(19) United States
(12) Patent Application Publication
(10) Pub. No.: US 2012/0295121 A1
(43) Pub. Date: Nov. 22, 2012

(54) FABRICATION OF MIRROR-LIKE COATINGS

(75) Inventors: Jianying Miao, Hung Shui Kiu (HK); Wei Li, Hung Hom (HK); Shing Hang Ng, Tai Po (HK); Lok Hang Keung, Tai Kok Tsui (HK); Tao Gong, Foshan City (CN)

(73) Assignee: S.T. Trading Company Limited, Quarry Bay (HK)

(21) Appl. No.: 13/469,605

(22) Filed: May 11, 2012

Related U.S. Application Data
(60) Provisional application No. 61/457,727, filed on May 20, 2011.

(51) Int. Cl. B32B 33/00; B05D 5/06

(52) U.S. Cl. 428/450; 427/162

(57) ABSTRACT

Multi-layer coatings suitable for imparting a decorative, durable mirror-like finish to substrates such as metals are provided which contain a base coating of epoxy, a mirror-like coating, and a scratch-resistant surface coating.

### CROSS-REFERENCE TO RELATED APPLICATION

This application claims priority to U.S. Provisional Application No. 61/457,727, filed May 20, 2011, and incorporated herein by reference in its entirety for all purposes.

### FIELD OF THE INVENTION

The invention pertains to multi-layer coatings useful for providing a decorative and durable mirror-like finish on various types of metal substrates.

### BACKGROUND OF THE INVENTION

One conventional metal surface treatment method is electroplating, which supplies the performances of anti-corrosion, hardness, durability and mirror-like gloss together with other accessorial treatment. However, electroplating is potentially harmful to the environment owing to the large quantity of toxic byproducts and wastes that is generated. The whole process therefore operates at high cost. This limits and blocks the further development of the electroplating industry. The development of alternative techniques for achieving functional mirror-like coating on target metals, including steel Q195-A and zinc alloy #3, which are low cost and environmentally friendly is therefore desirable.

### SUMMARY OF THE INVENTION

The present invention provides a coating system having at least three layers which is capable of achieving a multiple function mirror-like coating on metals such as steel and zinc alloy (zinc alloy #3 and steel Q 195-A). The three layers include a base coating of epoxy, which provides anti-corrosion protection for metal surfaces and enhances the adhesion of the mirror-like coating which is also applied to the substrate. The decorative mirror-like coating may be formed on the base coating by the reaction of silver salt solution and glucose solution. A surface coating is fabricated on the middle mirror-like coating layer, which protects the mirror-like coating from being oxidized and scratched. The entire coating system is low in cost and easily adaptable to mass production. The processes of coating mixture preparation and the coating layers are all environmentally friendly.

In one embodiment, the invention furnishes a method of providing a substrate with a multi-layer coating, the method comprising the steps of:
a) forming a base coating comprised of epoxy on a surface of the substrate;
b) forming a decorative mirror-like coating on the base coating by reacting an amine complex of silver, a reducing sugar and an acetylenic compound; and
c) forming a surface coating on the decorative mirror-like coating which is capable of protecting the decorative mirror-like coating against scratching.

Another aspect of the invention provides a substrate having a multi-layer coating on at least one surface, the multi-layer coating comprising a base coating comprised of cured epoxy, a decorative mirror-like coating comprised of silver on top of the base coating, and a surface coating comprised of polysilicone on top of the decorative mirror-like coating.

### DETAILED DESCRIPTION OF CERTAIN EMBODIMENTS OF THE INVENTION

The process of the present invention is a method of providing multiple layers of coatings to display a mirror-like performance, together with functions of anti-corrosion and anti-scratch. Detailed exemplary procedures for carrying out such method, including the preparation of coating mixtures and the coating of such mixtures on substrates, are described below in the Examples.

Suitable substrates for use in the present invention include, but are not limited to, metal substrates (e.g., steel, zinc alloys). Prior to application of the base coating, one or more initial preparation steps such as surface polishing, surface cleaning and/or surface pretreatment may be carried out. For example, the substrate surface may be polished using an abrasive method such the use of abrasive paper, vibrating grinder or drum grinder. The substrate surface may also be cleaned by contacting the surface with an aqueous surfactant solution while sonicating (i.e., exposing the surface to ultrasound for a period of time, e.g., at least 30 minutes), rinsing the surface with water, contacting the rinsed surface with a volatile organic solvent or mixture of volatile organic solvents (e.g., a mixture of acetone and ethanol) while sonicating (subjecting to ultrasound), rinsing the surface with additional volatile organic solvent, and drying. If so desired, the substrate may be subjected to a pretreatment wherein the surface is contacted with a silane such as gamma-aminopropyl triethoxysilane. The silane or mixture of silanes may be provided in the form of a solution (e.g., a solution in aqueous ethanol). The substrate may be ultrasonicated for a period of time (e.g., at least 10 minutes) while in contact with the silane. The silane-treated surface may then be dried (e.g., in an oven at 110° C. for more than 20 minutes), then cooled to room temperature.

Following any initial preparation steps as described above, an epoxy base coating is formed on the substrate surface. Typically, an epoxy resin is utilized to form the base coating on the substrate surface, wherein the epoxy resin is cured using a solidifier to provide a base coating comprised of cured epoxy.

Any of the epoxy resins known in the art may be utilized in the present invention. Epoxy resins are characterized by the presence of two or more three-membered cyclic ether groups (epoxy groups) per molecule. Particularly useful are diglycidyl ethers of bisphenol A, derived from bisphenol A and epichlorohydrin. Other suitable epoxy resins may include epoxy cresol novolac resins and polynuclear phenol-glycidyl ether-derived resins. Reactive diluents containing a single epoxy group per molecule, such as glycidyl 2-methyiphenyl ether, may be used in combination with the epoxy resin if so desired. Any of the known solidifiers (curing agents) for epoxy resins may be employed, including both catalytic curing agents and coreactive curing agents. Examples of catalytic curing agents include Lewis acid catalysts (e.g., complexes of boron trifluoride with amines or ethers and boron trichloride complexes) and Lewsis base catalysts (e.g., tertiary amines or polyamines converted into tertiary amines upon reaction with epoxide groups). Coreactive curing agents generally contain active hydrogen atoms and include, but are not limited to, polyamines (which may contain aliphatic, aromatic, cycloaliphatic and/or heterocyclic groups, for example), polyaminoamides, polyphenols, polymeric thiols, polycarboxylic acids, and anhydrides.

One or more leveling agents may be used in the base coating composition. Suitable leveling agents include, for example, polyacrylates and silicone-acrylates. The base coating composition may also contain an air release additive (defoaming agent) such as BYK-A530 silicone polymer air release additive and/or a silane coupling agent.

One or more organic solvents may be utilized in the base coating composition as well to serve as a vehicle for the other components. That is, the epoxy resin, solidifier, leveling agent and so forth may be dissolved in an organic solvent or mixture of organic solvents such as alcohols and ketones (e.g., C1-C6 aliphatic alcohols and C3-C6 aliphatic ketones such as acetone, ethanol, butanol, 4-hydroxy-4-methyl-2-pentanone). Preferably, the solvent is relatively volatile (e.g., normal boiling point not more than 100° C.) to facilitate its removal from the base coating composition once the base coating composition has been applied to the substrate surface.

In one embodiment of the invention, the base coating is formed as two layers (a lower layer and an upper layer). The lower layer may be first formed on the substrate surface by applying a lower layer composition comprised of leveling agent, solidifier and solvent (e.g., a ketone and/or alcohol). Before applying to the substrate surface, the lower layer composition may be degassed, by ultrasonication for example. Any suitable coating method may be used, such as brushing, dipping or spraying. The applied coating may then be heated under conditions effective to remove solvent (e.g., 50° C. for at least 6 hours) and provide a dried lower layer. An upper layer composition is then applied to the dried lower layer, using any of the same coating techniques. The upper layer composition may be comprised of epoxy resin, solidifier, leveling agent, reactive diluent and solvent (e.g., alcohol and/or ketone) and may be degassed by ultrasonication prior to application. Following application of the upper layer composition, the coated substrate may again be heated (e.g. 80° C. for at least 4 hours), under conditions effective to both remove solvent and induce curing of the epoxy resin by reaction with the solidifier.

A decorative mirror-like coating is then formed on the base coating by the following procedures. The surface of the base coating may be first cleaned or roughened by contacting the surface with an organic solvent or mixture of organic solvents (e.g., C1-C6 alcohols, C3-C6 ketones, in particular an acetone/ethanol mixture) and then water, suitably by rinsing. The cleaned substrates may then be dried under conditions effective to remove residual volatiles (e.g., in an oven at 90° C., with the substrate thereafter being cooled to room temperature before the next step). A sensitization step to further prepare the coated substrate for application of the mirror-like coating may then be carried out by contacting the base coating surface with an acidic solution containing stannous ions (prepared, for example, by dissolving stannous chloride into aqueous HCl). The coated substrate may, for example, be dipped into the acidic solution, rinsed with water, and then dried (e.g., in an oven at 90° C.).

The decorative mirror-like coating results from the reaction of a soluble amine complex of silver such as [Ag(NH₃)₂]⁺, a reducing sugar such as glucose, and an acetylenic compound such as butynediol. As a result of such reaction, the silver complex is converted, at least in part, to metallic silver, which plates onto the substrate surface. The decorative mirror-like coating thus formed is comprised of silver. A solution of the soluble silver complex may be prepared, for example, by dissolving a silver salt such as silver nitrate into water, adding caustic such as sodium hydroxide to form a precipitate, and then adding an amount of ammonium hydroxide effective to dissolve the precipitate (the resulting solution will contain [Ag(NH₃)₂]⁺). This solution may then be combined with a solution of reducing sugar (e.g., glucose) which also contains an acidic catalyst such as a carboxylic acid (e.g., citric acid, lactic acid) and a solution of the acetylenic compound (e.g., butynediol). The acetylenic compound solution may be first combined with the sugar solution and the resulting solution then combined with the silver amine complex solution to provide a mirror-like coating composition. The mirror-like coating composition is contacted with the coated substrate by, for example, immersing the coated substrate in the mirror-like coating composition, preferably immediately after such composition has been prepared. Contacting is typically continued for 5 to 10 minutes at approximately room temperature or such other conditions effective to form the desired mirror-like coating on the substrate, generally without stirring or vibration. Thereafter, the substrate may be rinsed with water and dried. If so desired, the mirror-like coating layer may be treated to improve its oxidation resistance by, for example, contacting the mirror-like coating layer with a solution of a thiol such as hexadecanethiol and a surfactant such as an ethoxylated nonylphenol (typically, at 30-50° C. for 1-10 minutes). Thereafter, the substrate may be rinsed with water and dried.

Following the formation of the mirror-like coating layer, a surface coating is formed on such layer to protect the mirror-like coating layer (e.g., from oxidation and scratching). Such surface coating may suitably be based on organic silicon-containing compounds such as silanes and organosilicates. Thus, the protective surface coating may be comprised of polysilicone (i.e., a composition comprised of silicon and oxygen). Organic silicon-containing compounds may be reacted, by hydrolysis and/or condensation reactions for example, to provide the protective coating. Illustrative organic silicon-containing compounds include, for example, silanes, tetraalkyl silicates such as tetraethylsilicate, and alkylalkoxysilanes such as methyltrimethoxysilane. An illustrative example of a suitable silane is 3-glycidoxypropyltrimethoxysilane although other epoxyfunctional silanes as well as other organosilanes having alkoxy substituents and/or substituents with functional groups other than epoxy groups may also be used. The organic silicon-containing compounds may be admixed, combined with water or other liquid medium such as an alcohol, and treated with an acid such as a carboxylic acid (e.g., acetic acid) to provide a surface coating composition. If desired or needed to adjust the appearance of the final coated substrate, a dye (in particular, a violet dye such as tri(4-(dimethylamino)phenyl)methylinium chloride) is also present in the surface coating composition. The substrate having the mirror-like coating thereon is contacted (by immersion, for example) with the surface coating composition for at least one minute, then subsequently heated (e.g., at 100° C. for more than 18 hours) to yield the coated substrate in accordance with the invention.

### EXAMPLES

1. Preparation of Coating Mixtures and Coating Layer with Anti-Corrosive Function.

1) Preparation of pretreatment mixture: Mix Silquest® A1100 (γ-aminopropyl triethoxysilane, product of Crompton) with DI water and ethanol. Stir for more than 10 minutes to obtain a uniform solution.

2) Preparation of base coating mixture with anti-corrosive function:
(1) Lower layer mixture: The mixture used to prepare the lower layer of the base coating includes a group A component and a group B component. The group A component is obtained by mixing acetone, ethanol and BYK-361N leveling agent (product of Byk). The group B component is composed of ethanol and TZ-550 solidifier (a cycloamine curing agent, supplied by Tzar Industrial Co., Ltd. in China).
(2) Upper layer mixture: The mixture used to prepare the upper layer of the base coating also includes a group A component and a group B component. The group A component includes butan-1-ol, 4-hydroxy-4-methyl-2-pentanone, acetone, CGE (glycidyl 2-methylphenyl ether), BYK-361N leveling agent and E-51 epoxy (liquid reaction product of epichlorohydrin and bisphenol-A; epoxide eq. ca. 190 g/eq). The ingredients are added in sequence and stirred until a uniform mixture is obtained. The group B component is the solidifier (curing agent) TZ-550.

3) Fabrication of the coating layer with anti-corrosive function (base coating).
(1) Surface polishing of substrates: Steel Q195-A or zinc alloy #3 substrates are polished with abrasive papers of #240, #360 and #800, respectively; a vibrating grinder or drum grinder can also be used to polish the same substrates using suitable grinding stones.
(2) Substrate cleaning: The polished substrates are immersed in a mixture of DI water and cleanser essence. The substrates are sonicated for more than 30 minutes. The samples are rinsed one by one using running DI water. The substrates are cleaned in 1:1 (vol.) acetone and ethanol by ultrasonication again for more than 30 minutes. The substrates are rinsed with running ethanol and then dried in air.
(3) Substrate pre-treatment: The cleaned and dried substrates are immersed in the pretreatment mixture, while ultrasonicating for more than 10 minutes. The samples are oven-dried at 110° C. for more than 20 minutes, and then cooled down to room temperature.
(4) Base coating lower layer mixture: The group A and group B components of the base coating lower layer are mixed by stirring vigorously. The mixture is degassed by ultrasonication for more than 5 minutes. The base coating lower layer mixture is coated by brushing, dipping or spraying on substrates pre-treated as described in step (3). The coated samples are then heated at 50° C. for more than 6 hours.
(5) Base coating upper layer mixture: The group A and group B components of the base coating upper layer are mixed by stirring vigorously. The mixture is degassed by ultrasonication for more than 10 minutes. The base coating upper layer mixture is coated onto the base coating lower layer by brush, dipping or spraying on substrates coated in step (3). The samples are heated at 80° C. for more than 4 hours.
   2.Preparation of Mirror-Like Coating Solutions and Coating Layer with Metal Decorative Function and Gloss:

1) Preparation of roughening solution: Mix acetone and ethanol at a volume ratio of 1:1 at room temperature. Store the roughening solution in a bottle with a lid.

2) Preparation of sensitizing solution: Add stannous chloride into concentrated hydrochloric acid (36%) at room temperature until the stannous chloride is dissolved. Add DI water to make the concentrations of stannous chloride and hydrochloric acid in the solution 5 g/L and 5 g/L, respectively.

3) Preparation of mirror-like coating solutions: Mirror-like coating solutions include solution A, B and C, in which:
(1) Solution A is prepared as follows to get a solution of [Ag(NH₃)₂]⁺ with a concentration of 10 g/L: Dissolve silver nitrate into DI water. Dissolve sodium hydroxide into a small amount of DI water, and add the solution of sodium hydroxide into the above-mentioned silver nitrate solution while stirring vigorously, to get khaki-colored precipitation. Add a suitable amount of 10% of ammonium hydroxide into above mixture until the precipitation is dissolved. Add DI water into the solution until the concentration of [Ag(NH₃)₂]⁺ in the solution is 10 g/L.
(2) Solution B is a solution of glucose in water and ethanol. Mix ethanol and DI water to provide a mixed solvent. Dissolve glucose and citric acid into the aforementioned mixed solvent. Add DI water to make the concentration of glucose in the solution 8 g/L.
(3) Solution C is a butynediol solution in DI water with a concentration of 8.6 g/L.

4) Preparation of anti-oxidant solution for mirror-like coating layer: The use of this solution is optional. Dissolve 1-hexadecanethiol into iso-propanol. Stir until the solution is uniform (solution A). Add surfactant of polyoxyethylene (9) nonylphenyl ether (IGEPAL CO-630) into DI water to provide solution B. Mix solution A and B to obtain a uniform solution.

5) Fabrication of mirror-like coating layer.
(1) Sample cleaning: Rinse the substrates coated with anti-corrosive base coating as described previously with running 1:1 (vol.) of acetone and ethanol, and then DI water, respectively. Dry the samples in oven at 90° C. Cool down the samples to room temperature in air.
(2) Sensitization of samples: Dip the cleaned and dried substrates coated with anti-corrosive coating into stannous chloride solution, and then rinse the samples with running DI water. Dry the samples in oven at 90° C., and then cool down to room temperature.
(3) Fabrication of mirror-like coating: solution A and B used to obtain the mirror-like coating will be mixed at a volume ratio of A:B=1:1 to 1:2. The reaction will be faster for ratio of A:B=1:2. At first, mix solution B and C while stirring, in which solution C is 5% of the total volume of A and B. Solution A is then added into above solution of B and C. Immerse substrates pre-treated by roughening and sensitizing steps at room temperature (ca. 20-25° C.) into above mixture solution immediately for ca. 4-6 min. The reaction is carried out without stirring or vibration, and a shiny mirror-like coating will be formed on the surface of the samples. Rinse the samples with DI water more than 3 times, and dry at room temperature.
(4) Anti-oxidation treatment of mirror-like coating layer (optional step): Immerse the samples with the mirror-like coating layer deposited thereon into the anti-oxidation solution at 40 ° C. for 5 min. Rinse the sample with DI water for more than 3 times, and dry at room temperature.
   3. Preparation of Surface Coating Mixtures with Anti-Scratch Function and Coating Layer.

1) Mix silanes of 3-glycidoxypropyltrimethoxysilane (A187), tetraethylsilicate (TEOS) and methyltrimethoxysilane (MTMS) at room temperature. Sonicate the mixture in an ultrasonic bath for 3 minutes. Add DI water into the above silane mixture at room temperature, and then sonicate for 3 minutes. Add acetic acid into the solution at room temperature, and treat at room temperature for more than 12 minutes. Butan-l-ol is added to dilute the coating product.

2) Violet dye of tris(4-(dimethylamino)phenyl)methylium chloride is added into above anti-scratch coating mixture to adjust the appearance of the coated sample if necessary.

3) Fabrication of the coating layer with anti-scratch function. Immerse the samples coated with the mirror-like coating layer in above anti-scratch coating mixture for more than 1 minute. Heat the samples at 100° C. for more than 18 hours.

What is claimed is:

1. A method of providing a substrate with a multi-layer coating, the method comprising the steps of:
a) forming a base coating comprised of epoxy on a surface of the substrate;
b) forming a decorative mirror-like coating on the base coating by reacting an amine complex of silver, a reducing sugar and an acetylenic compound; and
c) forming a surface coating on the decorative mirror-like coating which is capable of protecting the decorative mirror-like coating against scratching.

2. The method of claim 1, wherein the substrate is selected from the group consisting of metal substrates.

3. The method of claim 1, comprising an additional step prior to step a) of pretreating the surface of the substrate.

4. The method of claim 3, wherein the additional step comprises contacting the surface of the substrate with one or more silanes.

5. The method of claim 1, wherein the base coating is formed by reaction of an epoxy resin with a solidifier.

6. The method of claim 5, wherein the epoxy resin is a glycidyl ether of bisphenol A.

7. The method of claim 1, wherein the base coating is additionally comprised of a leveling agent.

8. The method of claim 1, wherein the amine complex of silver is [Ag(NH₃)₂]⁺.

9. The method of claim 1, wherein the reducing sugar is glucose.

10. The method of claim 1, wherein the acetylenic compound is butynediol.

11. The method of claim 1, wherein the surface coating is based on one or more organic silicon-containing compounds.

12. The method of claim 11, wherein the organic silicon-containing compounds are selected from the group consisting of silanes, tetraalkyl silicates, alkylalkoxysilanes and mixtures thereof.

13. The method of claim 11, wherein the surface coating is obtained by combining at least one silane, at least one tetraalkyl silicate, at least one alkylalkoxysilane with water and acid to provide a surface coating composition, contacting the surface coating composition with the decorative mirror-like coating, and heating the substrate.

14. The method of claim 13, wherein the surface coating composition is additionally comprised of a violet dye.

15. The method of claim 1, wherein after step a) and before step b) the base coating is contacted with an acidic solution containing stannous ions.

16. The method of claim 1, comprising an additional step prior to step a) of polishing the surface of the substrate.

17. The method of claim 1, comprising an additional step prior to step a) of cleaning the surface of the substrate.

18. The method of claim 1, comprising an additional step after step a) and before step b) of contacting the base coating with one or more organic solvents selected from the group consisting of C1-C6 aliphatic alcohols and C3-C6 aliphatic ketones.

19. The method of claim 1, comprising an additional step after step b) and before step c) of contacting the mirror-like coating with a solution comprised of a thiol and a surfactant.

20. A method of providing a metal substrate with a multi-layer coating, the method comprising the steps of:
a) pretreating a surface of the metal substrate by contacting the surface with a silane;
b) forming a base coating on the pretreated surface by first forming a lower layer comprised of leveling agent and solidifier on the pretreated surface followed by an upper layer on top of the lower layer, the upper layer being comprised of reactive diluent, leveling agent and epoxy resin;
c) forming a decorative mirror-like coating on the base coating by contacting the base coating with a stannous ion-containing solution and then a mixture comprised of [Ag(NH₃)₂]⁺, glucose, carboxylic acid and butynediol;
d) forming a surface coating on the decorative mirror-like coating by contacting the decorative mirror-like coating with a surface coating composition obtained by at least one silane, at least one tetraalkyl silicate, at least one alkylalkoxysilane with water and acid, contacting the surface coating composition with the decorative mirror-like coating, and heating the substrate.

21. A substrate having a multi-layer coating on at least one surface, the multi-layer coating comprising a base coating comprised of cured epoxy, a decorative mirror-like coating comprised of silver on top of the base coating, and a surface coating comprised of polysilicone on top of the decorative mirror-like coating.
